(19) United States
(12) Patent Application Publication
(10) Pub. No.: US 2015/0356770 A1
(43) Pub. Date: Dec. 10, 2015

(54) STREET VIEW MAP DISPLAY METHOD AND SYSTEM

(71) Applicant: Tencent Technology (Shenzhen) Company Limited, Shenzhen (CN)

(72) Inventor: Cong WAN, Shenzhen (CN)

(21) Appl. No.: 14/827,727

(22) Filed: Aug. 17, 2015

Related U.S. Application Data
(63) Continuation of application No. PCT/CN2014/072577, filed on Feb. 26, 2014.

(30) Foreign Application Priority Data
Mar. 4, 2013 (CN) 201310066729.4

(51) Int. Cl. G06T 17/05

(52) U.S. Cl. CPC G06T 17/05; G06T 2200/04

(57) ABSTRACT

A method and system for displaying a street view map are provided. The method includes: acquiring a site scene image of a street view; determining that the site scene comprises a three-dimensional model, acquiring the attribute information of the three-dimensional model and the stereoscopic information of the site scene; in the position coordinates of the real object in the site scene relative to the site scene, identifying and utilizing the position coordinates of the real object relative to the site scene identical to the position coordinates corresponding to the three-dimensional model contained in the attribute information of the three-dimensional model as position coordinates of the three-dimensional model relative to the site scene; and loading the three-dimensional model to render the site scene image.

### RELATED APPLICATION

This application claims priority to Chinese Patent Application No. 201310066729.4, titled “STREET VIEW MAP DISPLAY METHOD AND SYSTEM” and filed on Mar. 4, 2013, which is incorporated by reference in its entirety.

### FIELD OF THE TECHNOLOGY

The subject matter disclosed herein relates to the field of Internet technologies, and in particular, to a method and system for displaying a street view map.

### BACKGROUND OF THE DISCLOSURE

In recent years, more and more display manners of an Internet map service emerge. Especially, after a street view map goes online, a significant impact is brought to a traditional two-dimensional map browsing experience. The street view map is generally generated in a manner of combining a street view with a three-dimensional model. That is, after scene images of a series of continuous scene points that constitute the street view are shot, the scene images of the scene points can be mapped to the three-dimensional model as texture mapping, so as to display the street view map. However, there may be a mapping misplacement when the scene images of the scene points are mapped to the three-dimensional model as texture mapping. That is, there may be a mismatch between the three-dimensional model and a position of a real object, thus reducing the sense of realism and the effect of three-dimensional architecture for the street view map.

### SUMMARY

Embodiments of the present invention provide a method for displaying a street view map and system, which can improve the sense of realism and the effect of stereoscopic architecture for a three-dimensional map can be improved.

According to one aspect of the embodiments of the present invention, a method for displaying a street view map is provided, including the following steps:

acquiring a scene image of a scene point of a street view;

determining whether a scene of the scene point includes a three-dimensional model, and acquiring attribute information of the three-dimensional model and scene stereoscopic information of the scene point if the three-dimensional model is included, the attribute information of the three-dimensional model including at least location coordinates corresponding to the three-dimensional model, and the scene stereoscopic information of the scene point including at least location coordinates of real objects in the scene of the scene point relative to the scene point;

identifying, from the scene stereoscopic information of the scene point, the location coordinates of the real objects in the scene of the scene point relative to the scene point;

identifying, from the location coordinates of the real objects in the scene of the scene point relative to the scene point, location coordinates of a real object relative to the scene point that are the same as the location coordinates that correspond to the three-dimensional model and are included in the attribute information of the three-dimensional model, the identified location coordinates of the real object relative to the scene point being used as location coordinates of the three-dimensional model relative to the scene point; and

loading the three-dimensional model in the scene image of the scene point according to the location coordinates of the three-dimensional model relative to the scene point, and rendering the scene image of the scene point.

According to another aspect of the embodiments of the present invention, a system for displaying a street view map is provided, including:

a first acquiring unit, configured to acquire a scene image of a scene point of a street view; a determining unit, configured to determine whether a scene of the scene point includes a three-dimensional model; a second acquiring unit, configured to acquire attribute information of the three-dimensional model and scene stereoscopic information of the scene point in the case that the determining unit determines that the scene of the scene point includes the three-dimensional model, the attribute information of the three-dimensional model including at least location coordinates corresponding to the three-dimensional model, and the scene stereoscopic information of the scene point including at least location coordinates of real objects in the scene of the scene point relative to the scene point; an identifying unit, configured to identify, from the scene stereoscopic information of the scene point, the location coordinates of the real objects in the scene of the scene point relative to the scene point, and identify, from the location coordinates of the real objects in the scene of the scene point relative to the scene point, location coordinates of a real object relative to the scene point that are the same as the location coordinates that correspond to the three-dimensional model and are included in the attribute information of the three-dimensional model, the identified location coordinates of the real object relative to the scene point being used as location coordinates of the three-dimensional model relative to the scene point; a loading unit, configured to load the three-dimensional model in the scene image of the scene point according to the location coordinates of the three-dimensional model relative to the scene point; and a rendering unit, configured to render the scene image of the scene point in which the three-dimensional model is loaded.

In the embodiments according to the foregoing aspects of the present disclosure, after it is determined that a scene of a scene point includes a three-dimensional model, attribute information of the three-dimensional model and scene stereoscopic information of the scene point can be acquired; and further, location coordinates of the three-dimensional model relative to the scene point can be identified according to the attribute information of the three-dimensional model and the scene stereoscopic information of the scene point, so that the three-dimensional model can be loaded in the scene image of the scene point according to the location coordinates of the three-dimensional model relative to the scene point, and the scene image of the scene point can be rendered, to display a street view map. The embodiments of the present invention can avoid a mapping misplacement problem in a three-dimensional model, and therefore can improve the sense of realism and the effect of stereoscopic architecture for a street view map.

### BRIEF DESCRIPTION OF THE DRAWINGS

To describe the technical solutions of embodiments of the present invention more clearly, the following briefly introduces the accompanying drawings required in the embodiments. Apparently, the accompanying drawings in the following description show only some embodiments of the present invention, and a person of ordinary skill in the art may still derive other drawings from these accompanying drawings without creative efforts.

FIG. 1 is a flowchart of a method for displaying a street view map according to an embodiment of the present invention;

FIG. 2 is a flowchart of another method for displaying a street view map according to an embodiment of the present invention;

FIG. 3 is a structural diagram of a system for displaying a street view map according to an embodiment of the present invention; and

FIG. 4 is a structural diagram of another system for displaying a street view map according to an embodiment of the present invention.

### DESCRIPTION OF EMBODIMENTS

The following further clearly describes the technical solutions in embodiments of the present invention in detail with reference to the accompanying drawings. Apparently, the described embodiments are merely a part rather than all of the embodiments of the present invention. All other embodiments obtained by a person of ordinary skill in the art based on the embodiments of the present invention without creative efforts shall fall within the protection scope of the present disclosure.

Embodiments of the present invention provide a method and system for displaying a street view map, which can improve the sense of realism and the effect of stereoscopic architecture for a street view map. Detailed descriptions are given below separately.

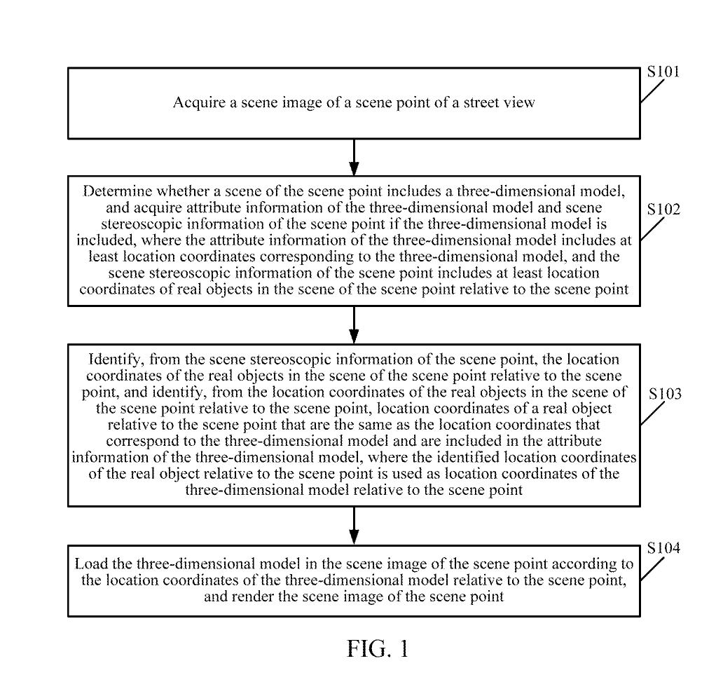

Referring to FIG. 1, FIG. 1 is a flowchart of a method for displaying a street view map according to an embodiment of the present invention. The method for displaying a street view map shown in FIG. 1 can be applied to various map display platforms, mobile terminals, or the like, which are not limited in this embodiment of the present invention. As shown in FIG. 1, the method for displaying a street view map starts from step S101.

Step S101: Acquire a scene image of a scene point for a street view.

The scene image of the scene point for the street view may be shot by using a shooting device, and the scene image of the scene point for the street view may also be shot by using a mobile device having a shooting function, which is not limited in this embodiment of the present invention.

The scene point refers to a coordinate point for shooting the scene image, and the scene image can be shot in 360 degrees at the coordinate point.

Step S102: Determine whether a scene of the scene point includes a three-dimensional model, and acquire attribute information of the three-dimensional model and scene stereoscopic information of the scene point if the three-dimensional model is included, where the attribute information of the three-dimensional model includes at least location coordinates corresponding to the three-dimensional model, and the scene stereoscopic information of the scene point includes at least location coordinates of real objects in the scene of the scene point relative to the scene point.

In this embodiment of the present invention, the attribute information of the three-dimensional model may further include a name of the real object corresponding to the three-dimensional model, which is not limited in this embodiment of the present invention.

In this embodiment of the present invention, it may be determined, according to an identifier of the scene point, whether a correspondence between the identifier of the scene point and the three-dimensional model exists in a database, and it is distinguished that the scene of the scene point includes the three-dimensional model if the correspondence exists, or it is distinguished that the scene of the scene point does not include the three-dimensional model if the correspondence does not exist.

The three-dimensional model refers to a model, constructed in a three-dimensional reconstruction manner, of the real object in the scene point.

Step S103: Identify, from the scene stereoscopic information of the scene point, the location coordinates of the real objects in the scene of the scene point relative to the scene point, and identify, from the location coordinates of the real objects in the scene of the scene point relative to the scene point, location coordinates of a real object relative to the scene point that are the same as the location coordinates that correspond to the three-dimensional model and are included in the attribute information of the three-dimensional model, where the identified location coordinates of the real object relative to the scene point are used as location coordinates of the three-dimensional model relative to the scene point.

Step S104: Load the three-dimensional model in the scene image of the scene point according to the location coordinates of the three-dimensional model relative to the scene point, and render the scene image of the scene point.

In an embodiment, after the three-dimensional model is loaded in the scene image of the scene point according to the location coordinates of the three-dimensional model relative to the scene point, the scene image of the scene point in which the three-dimensional model is loaded may be projected to a street-view spherical model, and then the scene image of the scene point is rendered, so that the street view map can be browsed in 360 degrees.

In an embodiment, if it is determined in step S102 that the scene of the scene point does not include the three-dimensional model, according to this embodiment of the present invention, the scene image of the scene point may also be rendered, which is not limited in this embodiment of the present invention.

In the method for displaying a street view map shown in FIG. 1, after it is determined that a scene of a scene point includes a three-dimensional model, attribute information of the three-dimensional model and scene stereoscopic information of the scene point can be acquired; and further, location coordinates of the three-dimensional model relative to the scene point can be identified according to the attribute information of the three-dimensional model and the scene stereoscopic information of the scene point, so that the three-dimensional model can be loaded in the scene image of the scene point according to the location coordinates of the three-dimensional model relative to the scene point, and the scene image of the scene point can be rendered, to display a street view map. The method for displaying a street view map shown in FIG. 1 can avoid a mapping misplacement in a three-dimensional model, and therefore, can improve the sense of realism and the effect of stereoscopic architecture for a street view map.

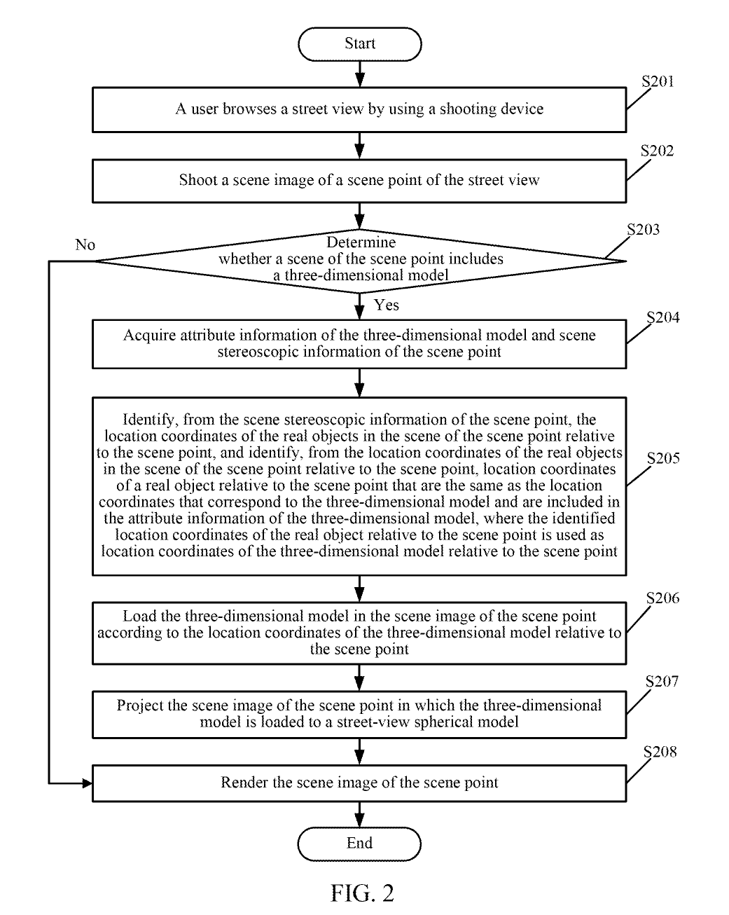

Referring to FIG. 2, FIG. 2 is a flowchart of another method for displaying a street view map according to an embodiment of the present invention. The method for displaying a street view map shown in FIG. 2 can be applied to various map presentation platforms, mobile terminals, or the like, which are not limited in this embodiment of the present invention. As shown in FIG. 2, the method for displaying a street view map may include the following steps.

Step S201: A user browses a street view by using a shooting device.

Step S202: Shoot a scene image of a scene point for the street view.

The image of the scene point for the street view may be shot by using a shooting device, or the image of the scene point for the street view may also be shot by using a mobile device having a shooting function, which is not limited in this embodiment of the present invention.

Step S203: Determine whether a scene of the scene point includes a three-dimensional model; perform step S204 to step S208 if the three-dimensional model is included; or perform step S208 if the three-dimensional model is not included.

In this embodiment of the present invention, it may be determined, according to an identifier of the scene point, whether a correspondence between the identifier of the scene point and the three-dimensional model exists in a database, and it is distinguished that the scene of the scene point includes the three-dimensional model if the correspondence exists, or it is distinguished that the scene of the scene point does not include the three-dimensional model if the correspondence does not exist.

The three-dimensional model refers to a model, constructed in a three-dimensional reconstruction manner, of a real object in the scene point.

Step S204: Acquire attribute information of the three-dimensional model and scene stereoscopic information of the scene point, where the attribute information of the three-dimensional model includes at least location coordinates corresponding to the three-dimensional model, and the scene stereoscopic information of the scene point includes at least location coordinates of real objects in the scene of the scene point relative to the scene point.

Step S205: Identify, from the scene stereoscopic information of the scene point, the location coordinates of the real objects in the scene of the scene point relative to the scene point, and identify, from the location coordinates of the real objects in the scene of the scene point relative to the scene point, location coordinates of a real object relative to the scene point that are the same as the location coordinates that correspond to the three-dimensional model and are included in the attribute information of the three-dimensional model, where the identified location coordinates of the real object relative to the scene point are used as location coordinates of the three-dimensional model relative to the scene point.

Step S206: Load the three-dimensional model in the scene image of the scene point according to the location coordinates of the three-dimensional model relative to the scene point.

Step S207: Project the scene image of the scene point in which the three-dimensional model is loaded to a street-view spherical model.

The street view map can be browsed in 360 degrees by means of step S207 described above.

Step S208: Render the scene image of the scene point.

The method for displaying a street view map shown in FIG. 2 can avoid a mapping misplacement in a three-dimensional model, and therefore can improve the sense of realism and the effect of stereoscopic architecture for a street view map.

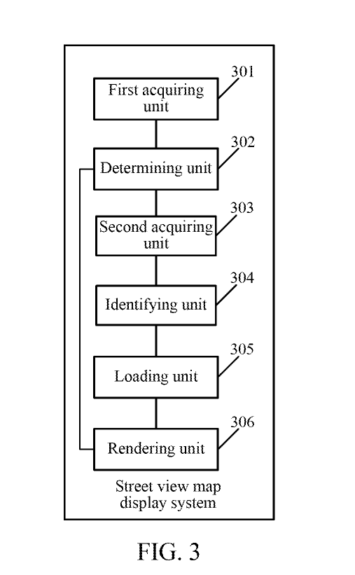

Referring to FIG. 3, FIG. 3 is a structural diagram of a system for displaying a street view map according to an embodiment of the present invention. The system for displaying a street view map shown in FIG. 3 can be applied to various map presentation platforms, mobile terminals, or the like, which are not limited in this embodiment of the present invention. As shown in FIG. 3, the system for displaying a street view map may include:

a first acquiring unit 301, configured to acquire a scene image of a scene point of a street view;

a determining unit 302, configured to determine whether a scene of the scene point includes a three-dimensional model;

a second acquiring unit 303, configured to acquire attribute information of the three-dimensional model and scene stereoscopic information of the scene point in the case that the determining unit 302 determines that the scene of the scene point includes the three-dimensional model, where the attribute information of the three-dimensional model includes at least location coordinates corresponding to the three-dimensional model, and the scene stereoscopic information of the scene point includes at least location coordinates of real objects in the scene of the scene point relative to the scene point;

an identifying unit 304, configured to identify, from the scene stereoscopic information of the scene point, the location coordinates of the real objects in the scene of the scene point relative to the scene point, and identify, from the location coordinates of the real objects in the scene of the scene point relative to the scene point, location coordinates of a real object relative to the scene point that are the same as the location coordinates that correspond to the three-dimensional model and are included in the attribute information of the three-dimensional model as location coordinates of the three-dimensional model relative to the scene point;

a loading unit 305, configured to load the three-dimensional model in the scene image of the scene point according to the location coordinates of the three-dimensional model relative to the scene point; and

a rendering unit 306, configured to render the scene image of the scene point in which the three-dimensional model is loaded.

In this embodiment of the present invention, the first acquiring unit 301 may be specifically configured to shoot the scene image of the scene point for the street view.

In this embodiment of the present invention, the rendering unit 306 is further configured to render the scene image of the scene point in the case that the determining unit 302 determines that the scene of the scene point does not include the three-dimensional model.

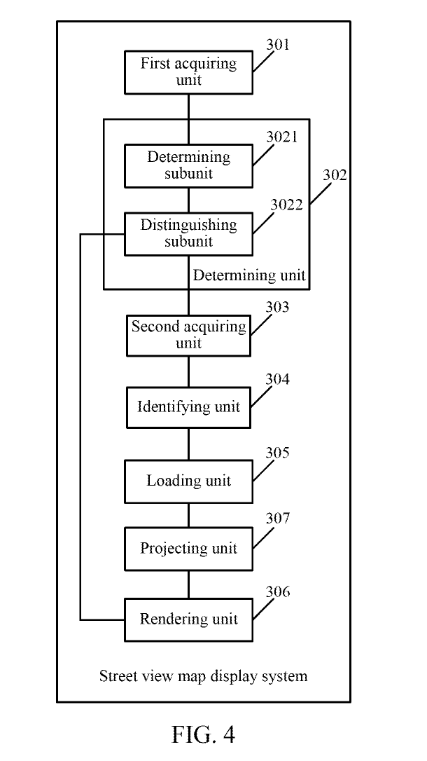

Referring to FIG. 4, FIG. 4 is a structural diagram of another system for displaying a street view map according to an embodiment of the present invention. The system for displaying a street view map shown in FIG. 4 is obtained by optimizing the system for displaying a street view map shown in FIG. 3. In the system for displaying a street view map shown in FIG. 4, the determining unit 302 includes:

a determining subunit 3021, configured to determine, according to an identifier of the scene point, whether a correspondence between the identifier of the scene point and the three-dimensional model exists in a database; and

a distinguishing subunit 3022, configured to distinguish that the scene of the scene point includes the three-dimensional model in a case that a determining result of the determining subunit 3021 is yes, or distinguish that the scene of the scene point does not include the three-dimensional model in a case that a determining result of the determining subunit 3021 is no.

Further, as compared with the system for displaying a street view map shown in FIG. 3, the system for displaying a street view map shown in FIG. 4 may further include:

a projecting unit 307, configured to project the scene image of the scene point in which the three-dimensional model is loaded to a street-view spherical model.

Correspondingly, the rendering unit 306 further renders the scene image of the scene point that is projected to the street-view spherical model and in which the three-dimensional model is loaded.

The system for displaying a street view maps shown in FIG. 3 and FIG. 4 can avoid a mapping misplacement in a three-dimensional model, and therefore can improve the sense of realism and the effect of stereoscopic architecture for a street view map.

According to an embodiment of the present invention, the method for displaying a street view map shown in FIG. 1 may be a method executed by units of the method for displaying a street view map shown in FIG. 3. For example, steps S101 and S103 shown in FIG. 1 may be executed by the first acquiring unit 301 and the identifying unit 304 shown in FIG. 3. Step S102 shown in FIG. 1 may be executed collectively by the determining unit 302 and the second acquiring unit 303 shown in FIG. 3. Step S104 shown in FIG. 1 may be executed collectively by the loading unit 305 and the rendering unit 306 shown in FIG. 3.

According to another embodiment of the present invention, units of the system for displaying a street view map shown in FIG. 4 can be separately or wholly combined into one or several other units, or one (or some) of the units may further be divided into multiple functionally smaller units. As an example, but the present invention is not limited thereto, the determining subunit 3021 may be combined with the distinguishing subunit 3022 to form an independent determining unit, which can implement same operations, without affecting the technical effects of the embodiments of the present invention. A person of ordinary skill in the art may understand that all or some of the steps in the method for displaying a street view map shown in FIG. 1 of the foregoing embodiments may construct, by a program (including program codes) instructing relevant hardware, for example, a processing element such as a central processing unit (CPU), the system for displaying a street view map shown in FIG. 3, and implement the image synthesizing method according to the embodiments of the present invention. The program may be stored in a computer readable storage medium. The storage medium may include: a flash disk, a read-only memory (ROM), a random access memory (RAM), a magnetic disk, an optical disc or the like.

The foregoing describes a method for displaying a street view map and system according to the embodiments of the present invention in detail. The principle and implementation of the present invention are described herein through specific examples. The description about the embodiments of the present invention is merely provided for ease of understanding of the method and core ideas of the present disclosure. Persons of ordinary skill in the art can make variations and modifications to the present disclosure in terms of the specific implementations and application scopes according to the ideas of the present disclosure. Therefore, the specification shall not be construed as a limit to the present invention. The scope of the present disclosure is defined by the appended claims

What is claimed is:

1. A method for displaying a street view map, comprising an image acquiring device on an apparatus, performing the following steps:
acquiring a scene image of a scene point of a street view;
determining whether a scene of the scene point comprises a three-dimensional model, and if yes, acquiring attribute information of the three-dimensional model and scene stereoscopic information of the scene point, wherein:
the attribute information of the three-dimensional model comprises at least location coordinates corresponding to the three-dimensional model, and
the scene stereoscopic information of the scene point comprises at least location coordinates of real objects in the scene of the scene point relative to the scene point;
identifying, from the scene stereoscopic information of the scene point, the location coordinates of the real objects in the scene of the scene point relative to the scene point;
identifying, from the location coordinates of the real objects in the scene of the scene point relative to the scene point, location coordinates of a real object relative to the scene point that are the same as the location coordinates that correspond to the three-dimensional model and are comprised in the attribute information of the three-dimensional model as location coordinates of the three-dimensional model relative to the scene point; and
loading the three-dimensional model in the scene image of the scene point according to the location coordinates of the three-dimensional model relative to the scene point, and rendering the scene image of the scene point of the street view.

2. The method according to claim 1, wherein after loading the three-dimensional model in the scene image of the scene point, and before rendering the scene image of the scene point, the method further comprises the following step:
projecting the three-dimensional model scene image of the scene point which is loaded to a street-view spherical model.

3. The method according to claim 1, wherein the acquiring of the scene image of the scene point of the street view comprises the following step:
shooting the scene image of the scene point for the street view;

4. The method according to claim 1, wherein the determining of whether the scene of the scene point which comprises the three-dimensional model, comprises the following step:
determining, according to an identifier of the scene point, whether a correspondence between the identifier of the scene point and the three-dimensional model exists in a database; and
distinguishing that the scene of the scene point comprises the three-dimensional model if the correspondence exists, or distinguishing that the scene of the scene point does not comprise the three-dimensional model if the correspondence does not exist.

5. The method according to claim 1, wherein the method further comprises the following step:
performing the step of rendering the scene image of the scene point of the street view if it is determined that the scene of the scene point does not comprise the three-dimensional model.

6. The method according to claim 1, wherein the scene point is a coordinate point used for shooting the scene image, and the scene image is shot in 360 degrees at the coordinate point.

7. The method according to claim 3, wherein in the step of shooting the scene image of the scene point for the street view, the scene image of the scene point for the street view is shot by using the image acquiring device, or the scene image of the scene point for the street view is shot by using a mobile device having an image acquiring function.

8. The method according to claim 3, wherein before the step of shooting the scene image of the scene point for the street view, the method further comprises the following step:
browsing, by a user, the street view by using the image acquiring device.

9. A system for displaying a street view map, comprising an apparatus having an image acquiring device and a program instructing relevant hardware executing program codes stored on a memory of the apparatus, which configure the apparatus to:
acquire a scene image of a scene point of a street view;
determine whether a scene of the scene point comprises a three-dimensional model:
if yes, acquire attribute information of the three-dimensional model and scene stereoscopic information of the scene point, the attribute information of the three-dimensional model comprising at least location coordinates corresponding to the three-dimensional model, and the scene stereoscopic information of the scene point comprising at least location coordinates of real objects in the scene of the scene point relative to the scene point;
identify, from the scene stereoscopic information of the scene point, the location coordinates of the real objects in the scene of the scene point relative to the scene point,
identify, from the location coordinates of the real objects in the scene of the scene point relative to the scene point, location coordinates of a real object relative to the scene point that are the same as the location coordinates that correspond to the three-dimensional model and are comprised in the attribute information of the three-dimensional model as location coordinates of the three-dimensional model relative to the scene point;
load the three-dimensional model in the scene image of the scene point according to the location coordinates of the three-dimensional model relative to the scene point; and
render the scene image of the scene point of the street view in which the three-dimensional model is loaded.

10. The system according to claim 9, wherein the apparatus is further configured to:
project the three-dimensional model scene image of the scene point which is loaded to a street-view spherical model; and
render the loaded three-dimensional model scene image of the scene point that is projected to the street-view in spherical model.

11. The system according to claim 9, wherein the apparatus is further configured to:
shoot the scene image of the scene point for the street view.

12. The system according to claim 9, wherein the apparatus is further configured to:
determine, according to an identifier of the scene point, whether a correspondence between the identifier of the scene point and the three-dimensional model exists in a database; and
distinguish that the scene of the scene point comprises the three-dimensional model if a case that a determining result of the determining subunit is yes, or distinguish that the scene of the scene point does not comprise the three-dimensional model in a case that a determining result of the determining subunit is no.

13. The system according to claim 9, wherein the apparatus is further configured to:
render the scene image of the scene point in the case that the scene of the scene point is determined that it does not comprise the three-dimensional model.

14. The system according to claim 9, wherein the scene point is a coordinate point used for shooting the scene image, and the scene image is shot in 360 degrees at the coordinate point.

15. The system according to claim 9, wherein the apparatus is configured to shoot the scene image of the scene point for the street view.

16. A non-transitory computer-readable program media, comprising program codes stored therein, wherein the program codes are executed by a program instructing hardware which cause an image acquiring device in an apparatus to perform functions to display a street view, wherein the functions comprising:
acquiring a scene image of a scene point of a street view;
determining whether a scene of the scene point comprises a three-dimensional model, and if yes, acquiring attribute information of the three-dimensional model and scene stereoscopic information of the scene point, wherein:
the attribute information of the three-dimensional model comprises at least location coordinates corresponding to the three-dimensional model, and
the scene stereoscopic information of the scene point comprises at least location coordinates of real objects in the scene of the scene point relative to the scene point;
identifying, from the scene stereoscopic information of the scene point, the location coordinates of the real objects in the scene of the scene point relative to the scene point;
identifying, from the location coordinates of the real objects in the scene of the scene point relative to the scene point, location coordinates of a real object relative to the scene point that are the same as the location coordinates that correspond to the three-dimensional model and are comprised in the attribute information of the three-dimensional model as location coordinates of the three-dimensional model relative to the scene point; and
loading the three-dimensional model in the scene image of the scene point according to the location coordinates of the three-dimensional model relative to the scene point, and rendering the scene image of the scene point of the street view.
